(19) United States
(12) Patent Application Publication
(10) Pub. No.: US 2014/0230745 A1
(43) Pub. Date: Aug. 21, 2014

(54) DOG TRAINING AND COMPTETITION APPARATUS AND METHODS

(71) Applicant: Patrice Anthony Coulanges, Monroe, NY (US)

(72) Inventor: Patrice Anthony Coulanges, Monroe, NY (US)

(21) Appl. No.: 13/769,363

(22) Filed: Feb. 17, 2013

(51) Int. Cl. A01K 1/04

(52) U.S. Cl. CPC A01K 1/04
USPC 119/452

(57) ABSTRACT

Described herein is an apparatus for training dogs for a desired behavior. Also described herein is an apparatus usable for various dog competitions. Also provided herein are methods for dog training and methods for dog competitions utilizing the apparatus described herein.

### FIELD

The technology relates in part to animal training devices and in particular canine training devices for competition and controlling aggression.

### BACKGROUND

Dogs often are trained to perform special behaviors or in competitions. Some training or competitions can be harmful to the dog, the trainer or both. The apparatus and methods described herein can be utilized to minimize harm to both the animal and the trainer.

### SUMMARY

Provided herein is a dog training device including: a substantially planar training area, a barrier dividing the defined training area into two substantially planar smaller training areas, a harness system for independently securing a dog in one or both smaller training areas, wherein the training area is defined by a first pair of parallel walls, and a second pair of parallel walls, the two pairs of parallel walls having an anchor point at each corner of the training area (e.g., corners formed where the first pair and the second pair of parallel walls meet), the barrier includes one or more openings, the openings being too small to allow passage of a dog, and the barrier separates one or more dogs from a training subject.

Also provided herein is a dog competition device, including: a substantially planar competition area, a barrier dividing competition area into two substantially planar smaller competition areas, a harness system for independently securing a dog in one or both smaller competition areas, wherein the competition area is defined by a first pair of parallel walls, and a second pair of parallel walls, the two pairs of parallel walls having an anchor point at each corner of the competition area (e.g., corners formed where the first pair and the second pair of parallel walls meet), the barrier includes one or more openings, the openings being too small to allow passage of a dog, and the barrier maintains separation of two dogs during a competition event.

In some embodiments, each of the two substantially planar smaller training/competition areas is substantially equal in size. In certain embodiments, each pair of parallel walls of the training/competition area independently has a total length of between about 3 feet and about 8 feet (e.g., about 3 feet, about 4 feet, about 5 feet, about 6 feet, about 7 feet, or about 8 feet). In some embodiments, each of the parallel walls can be a unitary beam, and in certain embodiments, each of the parallel walls be two or more beams equaling the total length. In some embodiments, the substantially planar training/competition area is secured to an underlying flat surface via the anchor points, and in some embodiments, the underlying substantially flat surface is chosen from the ground, a concrete surface, an asphalt surface, a wood surface, a metal surface, the like, or combinations thereof. In some embodiments, the walls of the training/competition area are made of one or more materials chosen from wood, plastic, metal, cement and combinations thereof.

In certain embodiments, the barrier has a height of between about 4 feet and about 6 feet (e.g., about 4 feet, about 4.5 feet, about 5 feet, about 5.5 feet, or about 6 feet). In some embodiments, the barrier is substantially the same width as the defined training/competition area. In certain embodiments, the barrier is secured to at least one pair of parallel walls defining the training/competition area. In certain embodiments, the barrier is made of one or more materials selected from wood, plastic, metal, fencing material and combinations thereof.

In some embodiments, the barrier allows a dog harnessed in one of the smaller defined training/competition areas to detect and/or observe a training/competition subject in the other smaller defined training/competition area. In certain embodiments, detection and/or observation of a training/competition subject is by scent, sound, visual observation, the like or combinations thereof. In some embodiments, the method further comprises one or more training/competition tools useful for training/competition a dog with respect to a training/competition subject. In certain embodiments, the training/competition subject is selected from a competition device, a behavior, a human, an animal, contraband, and explosives.

In some embodiments, the one or more openings in the barrier allow passage of one or more training/competition tools from one of the smaller training/competition areas to the other smaller training/competition area. In certain embodiments, the harness system further comprises anchor points and a collar system for independently securing a dog at each end of the smaller defined training/competition area.

In certain embodiments, the collars of the harness system are anchored at a substantially centrally located position on each of the walls located furthest from each other and parallel to the barrier. In some embodiments, the harness system is of sufficient length to allow a secured dog movement to within about 1 foot of the barrier. In certain embodiments, the collars are anchored using rope, cable or chain capable of withstanding 1000 or more pounds of pulling force. In some embodiments, the collars are capable of withstanding 1000 pounds of pulling force.

Provided also herein is a dog training method including (i) securing a dog to a dog training device, and (ii) training the dog in a desired behavior, wherein the dog training device includes: a substantially planar training area, a barrier dividing the defined training area into two substantially planar smaller training areas, a harness system for independently securing a dog in one or both smaller training areas, wherein the training area is defined by two pairs of parallel walls, the parallel walls having an anchor point at each corner of the training area, the barrier includes one or more openings, the openings being too small to allow passage of a dog, and the barrier separates one or more dogs from a training subject, wherein training the dog using the dog training device results in the dog being trained in a desired behavior. In some embodiments, the desired behavior is selected from the group consisting of anti-aggression behavior, detection behavior, performance behavior, protection behavior and combinations thereof.

Also provided herein is a dog competition method including (i) securing one or more dogs to a dog competition device, and (ii) competing the dogs against a timing device or each other, wherein the dog competition device includes: a substantially planar competition area, a barrier dividing competition area into two substantially planar smaller competition areas, a harness system for independently securing a dog in one or both smaller competition areas, wherein the competition area is defined by two pairs of parallel walls, the parallel walls having an anchor point at each corner of the competition area, the barrier includes one or more openings, the openings being too small to allow passage of a dog, and the barrier maintains separation of two dogs during a competition event, wherein competing one or more dogs against a timing device, each other, or against a timing device and each other results in determination of the competition winner. In certain embodiments, the competition is selected from the group consisting of tug of war, test of strength, test of speed, test of agility, obeying commands, and combinations thereof.

Certain embodiments are described further in the following description, examples, claims and drawings.

### BRIEF DESCRIPTION OF THE DRAWINGS

The drawings illustrate embodiments of the technology and are not limiting. For clarity and ease of illustration, the drawings are not made to scale and, in some instances, various aspects may be shown exaggerated or enlarged to facilitate an understanding of particular embodiments.

FIG. 1 is a top view of a dog training/competition device described herein. Also illustrated in FIG. 1 are a harness system and a training/competition system.

FIG. 2 is a side view of a dog training/competition device described herein. Illustrated in FIG. 2 are the anchor points utilized to secure the substantially planar training/competition surface to an underlying surface. Also illustrated in FIG. 2 are a harness system and a training/competition system.

FIG. 3. Illustrates a non-limiting materials list and partial assembly instructions for a dog training/competition device described herein.

### DETAILED DESCRIPTION

The dog training/competition apparatus and methods described herein can be used as a training device and also as an alternative to dogfighting, and other forms of aggressive dog competitions. For years mankind has bred and trained dogs for guarding and hunting, which contributed to dog breds with aggressive natures. As man moved away from hunting as a primary means of food gathering and the use of dogs as guards has been minimized due to electronic surveillance devices, the aggressive dogs were trained for sport as exercise and as a release for their aggressive natures. Dogfighting is one form of competition in which aggressive dogs sometimes are utilized. In many countries, dogfighting is not socially acceptable and often is illegal. The apparatus and methods described herein can be used as an alternative to dogfighting and other forms of dog competitions that can be harmful to dogs or trainers. The device and methods can be used to train dogs that have aggression problems towards each other, or humans, as it allows the dogs to be in close proximity to each other and/or one or more trainers while training/competition is being performed.

Dog training for use in various competitions or behaviors (e.g., anti-aggression behavior, detection behavior, performance behavior, protection behavior, the like and combinations thereof) sometimes can involve significant dangers to the dog, the trainer or the dog and the trainer. Some dangers involved in dog training/competition include harm to one or more dogs, harm to trainers, or harm to both dogs and trainers. Non-limiting examples of dangers and/or harm that may affect dogs or dog trainers include aggression between dogs being trained, aggression by a dog towards trainers, harm to the dog in performing one or more training behaviors, harm to the dog while being trained for competition or performance behaviors.

The training/competition device described herein can be utilized to minimize or eliminate some or all harm associated with dog training/competition.

### Dog Training and Competition Device

A device that can be used to train dogs and/or be used as a dog competition venue can be constructed in a manner that minimizes potential risks and harm to dogs, trainers or dogs and trainers. The device described herein offers an enclosed training/competition surface, a barrier to compartmentalize the training/competition area and/or separate dogs and/or training subjects from each other, and a harness system for secure restraint of the dogs during training/competition.

Training/Competition Surface

The training/competition area is defined by a first pair of parallel walls, and a second pair of parallel walls where the first pair of parallel walls is perpendicular to the second pair of parallel walls, in some embodiments, and in certain embodiments, the parallel walls have an anchor point at each corner of the training area (e.g., where the two pairs of parallel walls meet). The training/competition area includes a barrier with one or more openings, in some embodiments. The two smaller training/competition areas are substantially equal in size, in some embodiments. In certain embodiments, each pair of parallel walls of the training/competition area independently has a total length of between about 3 feet and about 8 feet (e.g., about 3 feet, about 4 feet, about 5 feet, about 6 feet, about 7 feet, or about 8 feet). The range of sizes allows the training/competition area to be configured for dogs of any size. In some embodiments, two or more beams equaling the total length of a parallel wall are utilized to generate a parallel wall. In some embodiments, the parallel walls can be secured to an underlying surface using anchor points located at an end of the main beams utilized as parallel walls (e.g., where the main beams of a first set of parallel walls meets a perpendicular wall (e.g., second set of parallel walls) to form a corner. Any suitable material can be used for the main beams. Non-limiting examples of materials that can be utilized to construct the main beams include wood, metal, high impact polymers, fiberglass, carbon fiber, the like or combinations thereof. In some embodiments the device can be enclosed using various materials attached to the main beams utilized as walls. In certain embodiments, the material attached to the main beams to enclose the device can be constructed from fencing material (e.g., metal fencing, plastic fencing, the like or combinations thereof).

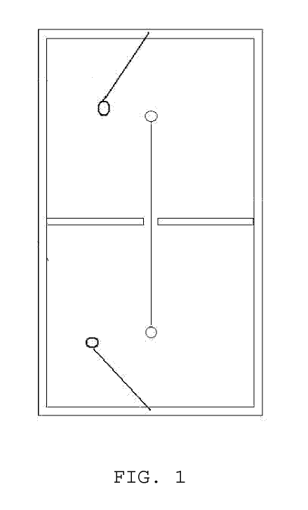

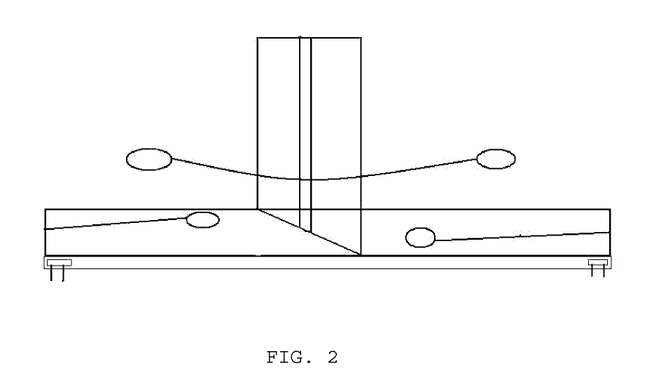

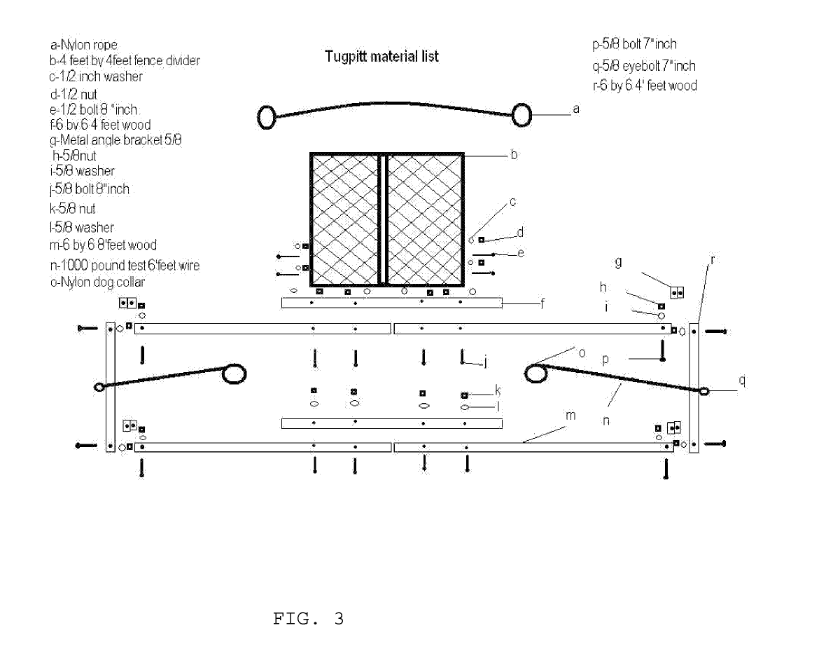

In some embodiments, the substantially planar training/competition area is secured to an underlying flat surface via anchor points at the end of the first set of parallel walls and/or the second set of parallel walls, and in some embodiments, the underlying substantially flat surface is chosen from the ground, a concrete surface, an asphalt surface, a wood surface, a metal surface, the like, or combinations thereof. In some embodiments, the walls of the training/competition area are made of one or more materials chosen from wood, plastic, metal, cement and combinations thereof. The walls are shown in FIGS. 1 to 3. The embodiment shown in FIG. 3 illustrates one set of parallel walls is formed from two beams that are joined to form a wall equaling the total length of the wall.

In certain embodiments, the training/competition area is surrounded by a gated fence perimeter which minimizes distractions to the training/competition by allowing the training/competition to proceed with minimal interference from spectators or other individuals not involved with the training and/or competition. The gated perimeter is configured to allow an additional 6 inches to about 12 inches of space between the training/competition area and the fence. This fenced “cushion” or internal gated space allows the dogs and non-training/non-competing individuals to be relatively safely separated from each other.

Barrier

A barrier often is utilized to separate the training/competition surface into two smaller substantially equal sized planar training/competition areas, as shown in FIGS. 1-3. In some embodiments, the barrier also is utilized to separate one or more dogs from a training/competition subject or from one or more other dogs. The barrier in the dog training/competition device described herein often has a height of between about 4 feet and about 6 feet, and often is chosen based on the type of training and/or competition and/or the breed or breeds of dogs trained using the device. That is a barrier described herein is about 4 feet, about 4.5 feet, about 5 feet, about 5.5 feet, or about 6 feet tall, in some embodiments. The barrier often is substantially the same width as the training/competition surface, which in turn often is determined by the length (e.g., or width) of one set of parallel walls. That is, a barrier often has a width of between about 3 feet and about 8 feet, between about 4 feet and about 7 feet, or between about 4 feet and about 6 feet. In some embodiments, the barrier is secured to at least one pair of parallel walls, and in certain embodiments the barrier is secured directly to the underlying surface beneath the training/competition surface (e.g., in non-portable applications). Any suitable fastening system can be utilized to secure the barrier. Non-limiting fastening systems include nut and bolt, eye screw and bolt, welding, latch and hook mechanism, straps, the like or combinations thereof.

A barrier can be made of any suitable material. Non-limiting examples of materials from which a barrier can be constructed include wood, plastic, metal, cement, fiberglass, fencing material, the like or combinations thereof. In some embodiments, the barrier material allows a dog harnessed in one of the smaller training/competition areas to detect and/or observe a training subject and/or another dog in the other smaller training/competition area. In certain embodiments, the detection is a visual detection. In some embodiments, the detection is auditory detection, and in certain embodiments, the detection is olfactory detection (e.g., by scent). A training subject is any person, dog, or inanimate object (e.g., contraband, chemicals, drugs, explosives, the likes or combinations thereof) for which a specific behavior or response is desired in the dog being trained. In some embodiments, the training subject is another dog. In certain embodiments, the training subject is a human. In some embodiments the training subject is an animal. In certain embodiments, the training subject is a specific behavior (e.g., anti-aggression behavior, detection behavior, performance behavior, protection behavior and combinations thereof)

Harness System

In addition to the training/competition surface and the barrier which acts to separate the dogs from each other or from training subjects, the dog training/competition device described herein also includes a harness system configured to secure one or more dogs to one pair of parallel walls, as shown in FIGS. 1 to 3. In some embodiments, the harness system comprises a dog collar, an eyebolt attached to the end pair of parallel walls, and a means of attaching the collar to an eyebolt in one of the end beams utilized as parallel walls. The harness system sometimes is anchored at a substantially centrally located position on each of the walls located furthest from each other and parallel to the barrier. In certain embodiments, the harness system is of sufficient length to allow a secured dog movement to within about 1 foot of the barrier.

In some embodiments the attachment means is a rope, chord or leash with at least a 1000 pound pull rating. Any suitable material can be utilized to manufacture the rope, chord or lease, with the proviso the material can withstand 1000 pounds or more of pulling force. In certain embodiments the attachment means is manufactured from a material chosen from nylon, leather, rope, metal, carbon fiber, the like or combinations thereof, and additionally can withstand 1000 pounds or more of pulling force. In some embodiments, the collar is made from a material that also withstands at least 1000 pounds of pulling force. Any suitable material can be utilized to manufacture the collar, with the proviso the material can withstand 1000 pounds or more of pulling force. In certain embodiments the collar is manufactured from a material chosen from nylon, leather, rope, metal, carbon fiber, the like or combinations thereof, and additionally can withstand 1000 pounds or more of pulling force. Collars and leashes made of suitable materials capable of withstanding at least 1000 pounds of pulling force rating are commercially available.

### Methods of Use

The dog training/competition device described herein can be utilized to train dogs to alter existing behaviors and/or to teach new behaviors (e.g., anti-aggression behavior, detection behavior, performance behavior, protection behavior and combinations thereof). The device also can be used to conduct competitions for 1 or more dogs. The competitions can be tests of strength, tests of agility, test of comprehension or tests of behavior. A training and/or competition method often involves the steps of providing a training/competition apparatus described herein, securing one or more dogs to the training/competition device, and training the dog or competing one or more dogs against a clock or some other apparatus (e.g., a force meter) or each other.

### EXAMPLES

The examples set forth below illustrate certain embodiments and do not limit the technology.

### Example 1

### Examples of the Embodiments

A1. A dog training device, comprising:
a substantially planar training area;
a barrier dividing the defined training area into two substantially planar smaller training areas;
a harness system for independently securing a dog in one or both smaller training areas; wherein
the training area is defined by a first pair of parallel walls and a second pair of parallel walls perpendicular to the first par if parallel walls, the two pairs of parallel walls comprising an anchor point at each corner of the training area formed where the first and second parallel walls meet,
the barrier includes one or more openings, the openings being too small to allow passage of a dog, and
the barrier separates one or more dogs from a training subject.
   A2 The device of embodiment A1, wherein each of the two substantially planar smaller training areas is substantially equal in size.
   A3. The device of embodiment A1, wherein each pair of parallel walls of the training area independently has a total length of between about 3 feet and about 8 feet.
   A3.1 The device of embodiment A3, wherein the parallel walls are two or more beams equaling the total length.
   A4. The device of embodiment A1, wherein the substantially planar training area is secured to an underlying substantially flat surface via the anchor points.
   A4.1. The device of embodiment A4, wherein the underlying substantially flat surface is chosen from the ground, a concrete surface, an asphalt surface, a wood surface, a metal surface, the like, or combinations thereof.
   A5. The device of embodiment A1, wherein the barrier has a height of between about 4 feet and about 6 feet.
   A6. The device of embodiment A1, wherein the barrier is substantially the same width as the defined training area.
   A7. The dog training device of embodiment A1, wherein the barrier is secured to at least one pair of parallel walls defining the training area.
   A8. The dog training device of embodiment A1, wherein the barrier is secured to the ground.
   A8.1. The dog training device of embodiment A1, wherein the walls of the training area are made of one or more materials selected from wood, plastic, metal, cement and combinations thereof.
   A8.2 The dog training device of embodiment A1, wherein the barrier is made of one or more materials selected from wood, plastic, metal, fencing material and combinations thereof.
   A9. The dog training device of embodiment A1, wherein the barrier allows a dog harnessed in one of the smaller defined training areas to detect and/or observe a training subject in the other smaller defined training area.
   A9.1. The dog training device of embodiment A9, wherein detection and/or observation of a training subject is by scent, sound or visual observation.
   A10. The dog training device of embodiment A1, further comprising one or more training tools useful for training a dog with respect to a training subject.
   A10.1. The dog training device of embodiment A10, wherein the training subject is selected from a competition device, a behavior, a human, an animal, contraband, and explosives.
   A11. The dog training device of embodiment A1, wherein the one or more openings in the barrier allow passage of one or more training tools from one of the smaller training areas to the other smaller training area
   A12. The dog training device of embodiment A1, wherein the harness system further comprises anchor points and a collar system for independently securing a dog at each end of the smaller defined training area
   A12.1. The dog training device of embodiment A10, wherein the collars of the harness system are anchored at a substantially centrally located position on each of the walls located furthest from each other and parallel to the barrier.
   A12.2. The dog training device of embodiment A1, wherein the harness system is of sufficient length to allow a secured dog movement to within about 1 foot of the barrier.
   A12.3 The dog training device of embodiment 10.1, wherein the collars are anchored using rope, cable or chain capable of withstanding 1000 or more pounds of pulling force.
   A12.4. The dog training device of embodiment A1, wherein the collars are rated for at least 1000 pounds of pulling force.
   B1. A dog competition device, comprising:
a substantially planar competition area;
a barrier dividing competition area into two substantially planar smaller competition areas;
a harness system for independently securing a dog in one or both smaller competition areas; wherein
the competition area is defined by a first pair of parallel walls and a second pair of parallel walls perpendicular to the first par if parallel walls, the two pairs of parallel walls comprising an anchor point at each corner of the competition area formed where the first and second parallel walls meet,
the barrier includes one or more openings, the openings being too small to allow passage of a dog, and
the barrier maintains separation of two dogs during a competition event.
   B2 The device of embodiment B1, wherein each of the two substantially planar smaller competition areas is substantially equal in size.
   B3. The device of embodiment B1, wherein each pair of parallel walls of the competition area independently has a total length of between about 3 feet and about 8 feet.
   B3.1 The device of embodiment B3, wherein the parallel walls are two or more beams equaling the total length.
   B4. The device of embodiment B1, wherein the substantially planar competition area is secured to the ground via the anchor points.
   B5. The device of embodiment B1, wherein the barrier has a height of between about 4 feet and about 6 feet.
   B6. The device of embodiment B1, wherein the barrier is substantially the same width as the competition area.
   B7. The dog competition device of embodiment B1, wherein the barrier is secured to at least one pair of parallel walls defining the competition area.
   B8. The dog competition device of embodiment B1, wherein the barrier is secured to the ground.
   B8.1. The dog competition device of embodiment B1, wherein the walls of the competition area are made of one or more materials selected from wood, plastic, metal, cement and combinations thereof.
   B8.2 The dog competition device of embodiment B1, wherein the barrier is made of one or more materials selected from wood, plastic, metal, fencing material and combinations thereof.
   B9. The dog competition device of embodiment B1, wherein the barrier allows a dog harnessed in one of the smaller competition areas to detect and/or observe a competition subject in the other smaller competition area.
   B9.1. The dog competition device of embodiment B9, wherein detection and/or observation of a competition subject is by scent, sound or visual observation.
   B10. The dog competition device of embodiment B1, further comprising one or more competition tools useful for competition a dog with respect to a competition subject.
   B10.1. The dog competition device of embodiment B10, wherein the competition subject is selected from a competition device, a behavior, a human, an animal, contraband, and explosives.
   B11. The dog competition device of embodiment B1, wherein the one or more openings in the barrier allow passage of one or more competition tools from one of the smaller competition areas to the other smaller competition area
   B12. The dog competition device of embodiment B1, wherein the harness system further comprises anchor points and a collar system for independently securing a dog at each end of the smaller competition area
   B12.1. The dog competition device of embodiment B10, wherein the collars of the harness system are anchored at a substantially centrally located position on each of the walls located furthest from each other and parallel to the barrier.
   B12.2. The dog competition device of embodiment B1, wherein the harness system is of sufficient length to allow a secured dog movement to within about 1 foot of the barrier.
   B12.3 The dog competition device of embodiment 10.1, wherein the collars are anchored using rope, cable or chain capable of withstanding 1000 or more pounds of pulling force.
   B12.4. The dog competition device of embodiment B1, wherein the collars are rated for at least 1000 pounds of pulling force.
   C1. A dog training method comprising:
securing a dog to a dog training device, and
training the dog in a desired behavior, wherein the dog training device comprises:
   a substantially planar training area;
   a barrier dividing the defined training area into two substantially planar smaller training areas;
   a harness system for independently securing a dog in one or both smaller training areas; wherein
   the training area is defined by two pairs of parallel walls, the parallel walls having an anchor point at each corner of the training area,
   the barrier includes one or more openings, the openings being too small to allow passage of a dog, and
   the barrier separates one or more dogs from a training subject,
wherein training the dog using the dog training device results in the dog being trained in a desired behavior.
   C2. The method of embodiment C1, wherein the desire behavior is selected from the group consisting of anti aggression behavior, detection behavior, performance behavior, protection behavior and combinations thereof.
   D1. A dog competition method comprising:
securing one or more dogs to a dog competition device, and
competing the dogs against a timing device or each other, wherein the dog competition device comprises:
a substantially planar competition area;
a barrier dividing competition area into two substantially planar smaller competition areas;
a harness system for independently securing a dog in one or both smaller competition areas; wherein
the competition area is defined by two pairs of parallel walls, the parallel walls having an anchor point at each corner of the competition area,
the barrier includes one or more openings, the openings being too small to allow passage of a dog, and
the barrier maintains separation of two dogs during a competition event,
   wherein competing one or more dogs against a timing device, each other, or against a timing device and each other results in determination of the competition winner.
   D2. The method of embodiment D1, wherein the competition is selected from the group consisting of tug of war, test of strength, test of speed, test of agility, obeying commands, and combinations thereof.

The entirety of each patent, patent application, publication and document referenced herein hereby is incorporated by reference. Citation of the above patents, patent applications, publications and documents is not an admission that any of the foregoing is pertinent prior art, nor does it constitute any admission as to the contents or date of these publications or documents.

Modifications may be made to the foregoing without departing from the basic aspects of the technology. Although the technology has been described in substantial detail with reference to one or more specific embodiments, those of ordinary skill in the art will recognize that changes may be made to the embodiments specifically disclosed in this application, yet these modifications and improvements are within the scope and spirit of the technology.

The technology illustratively described herein suitably may be practiced in the absence of any element(s) not specifically disclosed herein. Thus, for example, in each instance herein any of the terms “comprising,” “consisting essentially of,” and “consisting of” may be replaced with either of the other two terms. The terms and expressions which have been employed are used as terms of description and not of limitation, and use of such terms and expressions do not exclude any equivalents of the features shown and described or portions thereof, and various modifications are possible within the scope of the technology claimed. The term “a” or “an” can refer to one of or a plurality of the elements it modifies (e.g., “a reagent” can mean one or more reagents) unless it is contextually clear either one of the elements or more than one of the elements is described. The term “about” as used herein refers to a value within 10% of the underlying parameter (i.e., plus or minus 10%), and use of the term “about” at the beginning of a string of values modifies each of the values (i.e., “about 1, 2 and 3” refers to about 1, about 2 and about 3). For example, a weight of “about 100 grams” can include weights between 90 grams and 110 grams. Further, when a listing of values is described herein (e.g., about 50%, 60%, 70%, 80%, 85% or 86%) the listing includes all intermediate and fractional values thereof (e.g., 54%, 85.4%). Thus, it should be understood that although the present technology has been specifically disclosed by representative embodiments and optional features, modification and variation of the concepts herein disclosed may be resorted to by those skilled in the art, and such modifications and variations are considered within the scope of this technology.

Certain embodiments of the technology are set forth in the claim(s) that follow(s).

What is claimed is:

1. A dog training device, comprising:
a substantially planar training area;
a barrier dividing the defined training area into two substantially planar smaller training areas;
a harness system for independently securing a dog in one or both smaller training areas; wherein
the training area is defined by a first pair of parallel walls and a second pair of parallel walls perpendicular to the first par if parallel walls, the two pairs of parallel walls comprising an anchor point at each corner of the training area formed where the first and second parallel walls meet,
the barrier includes one or more openings, the openings being too small to allow passage of a dog, and
the barrier separates one or more dogs from a training subject.

2. The device of embodiment 1, wherein each pair of parallel walls of the training area independently has a total length of between about 3 feet and about 8 feet.

3. The device of embodiment 1, wherein the substantially planar training area is secured to an underlying substantially flat surface via the anchor points.

4. The device of embodiment 1, wherein the barrier has a height of between about 4 feet and about 6 feet.

5. The device of embodiment 1, wherein the barrier is substantially the same width as the defined training area.

6. The dog training device of embodiment 1, wherein the barrier is secured to at least one pair of parallel walls defining the training area.

7. The dog training device of embodiment 1, wherein the barrier is secured to the ground.

8. The dog training device of embodiment 1, wherein the walls of the training area are made of one or more materials selected from wood, plastic, metal, cement and combinations thereof.

9. The dog training device of embodiment 1, wherein the barrier is made of one or more materials selected from wood, plastic, metal, fencing material and combinations thereof.

10. The dog training device of embodiment 1, wherein the barrier allows a dog harnessed in one of the smaller defined training areas to detect and/or observe a training subject in the other smaller defined training area.

11. The dog training device of embodiment 1, wherein the harness system further comprises anchor points and a collar system for independently securing a dog at each end of the smaller defined training area

12. A dog competition device, comprising:
a substantially planar competition area;
a barrier dividing competition area into two substantially planar smaller competition areas;
a harness system for independently securing a dog in one or both smaller competition areas; wherein
the competition area is defined by a first pair of parallel walls and a second pair of parallel walls perpendicular to the first par if parallel walls, the two pairs of parallel walls comprising an anchor point at each corner of the competition area formed where the first and second parallel walls meet,
the barrier includes one or more openings, the openings being too small to allow passage of a dog, and
the barrier maintains separation of two dogs during a competition event.

13. The device of embodiment 12, wherein each pair of parallel walls of the competition area independently has a total length of between about 3 feet and about 8 feet.

14. The device of embodiment 12, wherein the substantially planar competition area is secured to the ground via the anchor points.

15. The device of embodiment 12, wherein the barrier has a height of between about 4 feet and about 6 feet.

16. The device of embodiment 12, wherein the barrier is substantially the same width as the competition area.

17. The dog competition device of embodiment 12, wherein the barrier is secured to at least one pair of parallel walls defining the competition area.

18. The dog competition device of embodiment 12, wherein the barrier is secured to the ground.

19. The dog competition device of embodiment 12, wherein the walls of the competition area are made of one or more materials selected from wood, plastic, metal, cement and combinations thereof.

20. The dog competition device of embodiment 12, wherein the barrier is made of one or more materials selected from wood, plastic, metal, fencing material and combinations thereof.

21. The dog competition device of embodiment 12, wherein the barrier allows a dog harnessed in one of the smaller competition areas to detect and/or observe a competition subject in the other smaller competition area.

22. The dog competition device of embodiment 12, wherein the harness system further comprises anchor points and a collar system for independently securing a dog at each end of the smaller competition area

23. A dog competition method comprising:
securing one or more dogs to a dog competition device, and
competing the dogs against a timing device or each other, wherein the dog competition device comprises:
a substantially planar competition area;
a barrier dividing competition area into two substantially planar smaller competition areas;
a harness system for independently securing a dog in one or both smaller competition areas; wherein
the competition area is defined by two pairs of parallel walls, the parallel walls having an anchor point at each corner of the competition area,
the barrier includes one or more openings, the openings being too small to allow passage of a dog, and
the barrier maintains separation of two dogs during a competition event, wherein competing one or more dogs against a timing device, each other, or against a timing device and each other results in determination of the competition winner.
